(19) United States
(12) Patent Application Publication
(10) Pub. No.: US 2011/0217507 A1
(43) Pub. Date: Sep. 8, 2011

(54) Fishnet Hose Stocking a fastened tube for utility lines and hoses in aquatic/outdoor environments

(76) Inventor: Harold M. Kalkstein, New York, NY (US)

(21) Appl. No.: 12/698,572

(22) Filed: Mar. 3, 2010

(51) Int. Cl. B32B 25/10

(52) U.S. Cl. 428/100; 442/1

(57) ABSTRACT

What is new about this-invention (versus previous products) is the use of rubberized PVC mesh fabric and VELCRO® fasteners and straps, along the full length and ends Of the stocking ie. Tube, in order to organize, bind and protect utility hoses, lines and cables in an aquatic/outdoor and indoor environment. Also, VELCRO® straps sewn onto the edges of the Tube also distinguishes this invention that allows the Tube to hang from railings and other fixed objects.

The product (FUS ie. Fishnet Utili-Tube Stocking) is a rubberized mesh PVC fabric, In yellow, orange, beige, black or white color that is cut in 10 or 20″ inch widths, and 25 ft and 50 ft lengths (can attach 2 or more to extend to 50 ft and 100 ft etc). Two black Velcro® (ie. hook and eye) 2″ inch strips are sewn lengthwise onto opposite sides of the long edges of the mesh fabric so that when rolled into a cylinder the Velcro® strips stick together (sewn “hook” Velcro® up on one side and “eye” Velcro® down on the other side). The ends of the mesh fabric also have 2″ Velcro® strips on opposite sides of the mesh so that 2 or more tubes can be attached together. In addition, 4 Velcro® straps (in the 25 ft tube) or 8 Velcro® straps (in the 50 ft tube) are sewn perpendicular onto one edge of The tube so that the tube (when closed) can hang from a railing or other object that allows the closed tube to hang or be attached.

### BACKGROUND OF THE INVENTION

Previous attempts to consolidate Utility Hoses and lines (water, electric, cable TV, telephone etc) into one manageable grouping included:
1) A zippered canvas material “sleeve”
2) Tying them together with external “twist ties”, or string and ropes, or Velcro® bands or strips.
   However, various shortcomings and problems exist with prior approaches including:
1) rusting or salt infestation into the zippers
2) inability of water to run-through those non-porous canvas fabrics
3) separating, tearing and weathering of individual hoses and cables when using only thin Velcro® strips or bands to bind the hoses and cables
4) rusting or tearing of “twist ties” and string and ropes
5) using only one color without choice of marine yellow or emergency orange or black or white.

### BRIEF SUMMARY OF THE INVENTION

A porous, rubberized PVC mesh stocking ie. Tube, fastened lengthwise with Velcro® (ie hook and eye) strips sewn the full length of the fabric that functions to group together or consolidate water hoses, electric cords, TV, cable, audio, video and phone cables. It solves problems with existing products that use zippers that rust or clog with salt, and which retain water that will cause electric shocks and deterioration of cables.

### BRIEF DESCRIPTION OF DRAWINGS

FIG. 1—TOP VIEW—FISHNET UTILI-TUBE STOCKING (FUS) is OPEN FLAT Showing full length PVC mesh OPEN, with VELCRO® along sides and ends.

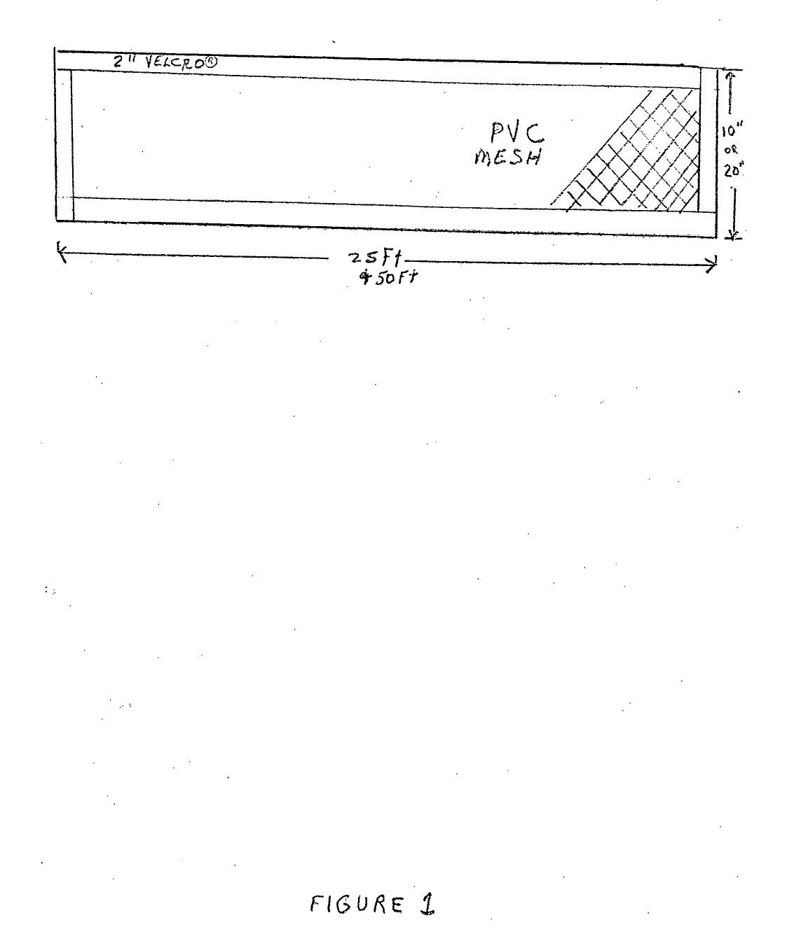

FIG. 2—FRONT VIEW—FUS TUBE is OPEN showing end of open tube with VELCRO Strips on opposite sides (Top and Bottom—“hooks and eye”) and ends of PVC fabric

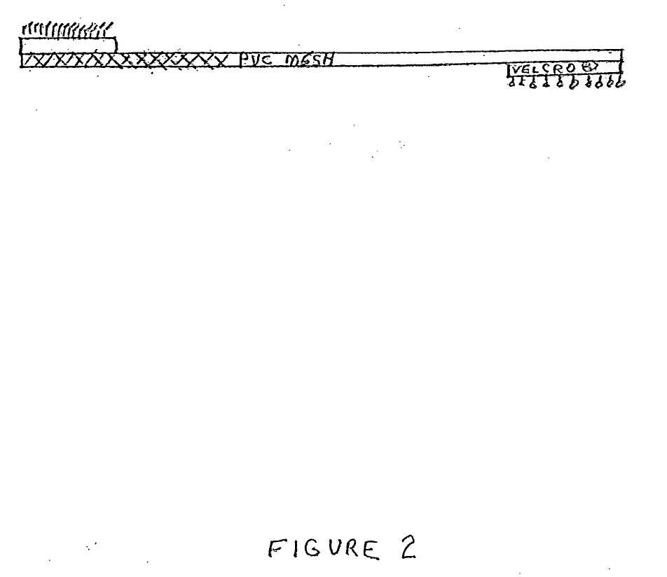

FIG. 3—FRONT VIEW—FUS TUBE is CLOSED with VELCRO® strips sealed.

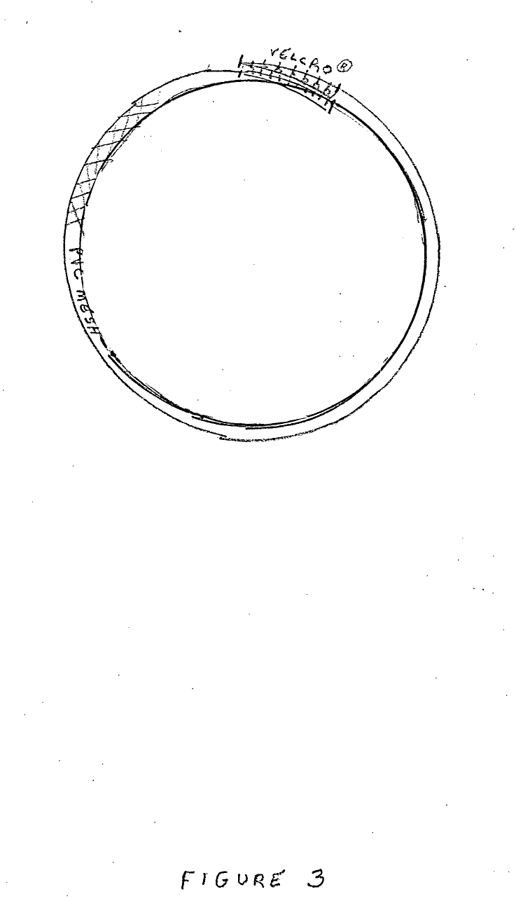

FIG. 4—FRONT VIEW—SHOWS EDGE OF FUS TUBE with multiple, double VELCRO® STRAPS attached EACH 12″ LONG, sewn at specific intervals (both male and female configured straps together) and sewn perpendicular to FUS tube.

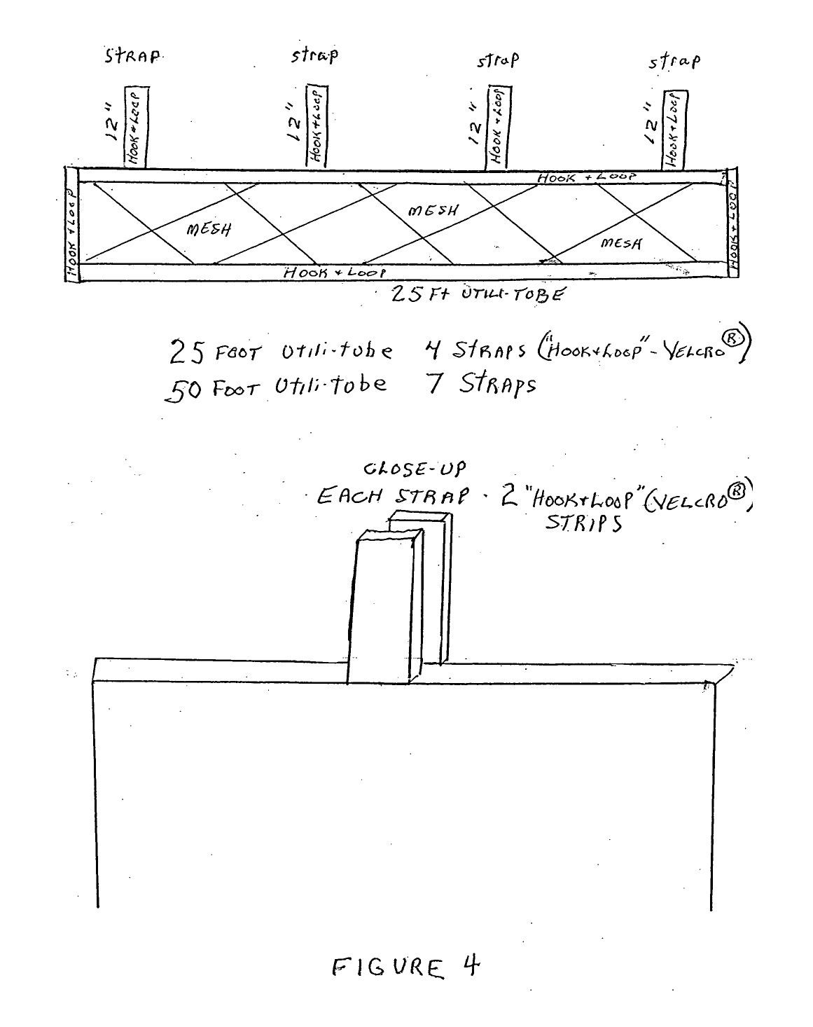

### DETAILED DESCRIPTION OF THE INVENTION

A rubberized PVC mesh fabric is cut to appropriate widths and lengths from large rolls of the mesh PVC fabric in yellow, emergency orange, beige, black or white colors. VELCRO® (ie. Hook and eye) strips are sewn along the long edges of each side of the mesh material. Thus, water runs through the fabric without accumulating within the hoses and cords. Accumulating water has the risk of causing electric shocks in electric cords and could wear through and cause erosion of the TV, phone and other utility lines and cords.

Also, rather than fastening a zipper along the long edge of a solid, PVC or canvas material, instead this invention uses VELCRO® strips to fasten the long edges of the “stocking” ie. Tube together. This fastener (hook and eye) does not prevent the water from running through the mesh fabric since it is only 2″ inch wide. Therefore water cannot accumulate within the hoses, lines and cords.

1) A rubberized mesh PVC fabric cut into specific sizes to make a tube when rolled and fastened

2) Using VELCRO® (ie hook and eye) strips sewn along the opposite edges of each lengthwise side of PVC mesh as fasteners for the stocking ie. Tube.

3) Also, VELCRO® strips at ends to connect 2 or more stockings ie. Tubes, Together.

4) Also, 2 VELCRO® (male and female configurations) STRAPS at specific Intervals (4 on the 25 ft, 8 on the 50 ft tube) allowing the Tube to hang from railings and other fixed objects.
